(19) United States
(12) Patent Application Publication
(10) Pub. No.: US 2013/0318278 A1
(43) Pub. Date: Nov. 28, 2013

(54) COMPUTING DEVICE AND METHOD FOR ADJUSTING BUS BANDWIDTH OF COMPUTING DEVICE

(71) Applicant: CHIH-HUANG WU, Tu-Cheng (TW)

(72) Inventor: CHIH-HUANG WU, Tu-Cheng (TW)

(73) Assignee: HON HAI PRECISION INDUSTRY CO., LTD., Tu-Cheng (TW)

(21) Appl. No.: 13/535,369

(22) Filed: Jun. 28, 2012

(30) Foreign Application Priority Data
May 28, 2012 (TW) 101118941

(51) Int. Cl. G06F 13/20

(52) U.S. Cl. 710/313

(57) ABSTRACT

In a method for adjusting bus bandwidth applied on a computing device, the computing device includes a bus controller and several graphics processing units (GPUs). The bus controller establishes a data flow of each signal channel of the peripheral component interconnect express (PCI-E) bus connected to each GPU, and obtains a total data flow of the PCI-E bus connected to each GPU according to the data flow of each of the signal channels. If there is a fully-utilized GPU according to the total data flow of the PCI-E bus; the method locates an available idle signal channel of the PCI-E bus according to the data flow of each of signal channels, and reroutes the data flow of the fully-utilized GPU to the idle signal channel using a switch of the bus controller.

### BACKGROUND

1. Technical Field

Embodiments of the present disclosure relate to peripheral component interconnect express (PCI-E) bus management methods of computing devices, and more particularly to a computing device and a method for adjusting bus bandwidth of the computing device.

2. Description of Related Art

A graphics processing unit (GPU) is a core component of a graphics card of computing devices, and determines the performance of a graphics card. Many enterprise servers use multiple GPUS to do complex computing, which needs a large PCI-E bus bandwidth. Balancing the PCI-E bus bandwidth occupied by each GPU to keep computing smooth is a technical and a significant problem.

### BRIEF DESCRIPTION OF THE DRAWINGS

FIG. 1 is a block diagram of one embodiment of a computing device including a bus bandwidth adjusting system.

FIG. 2 is a block diagram of one embodiment of function modules of the bus bandwidth adjusting system in FIG. 1.

FIG. 3 illustrates a flowchart of one embodiment of a method for adjusting bus bandwidth of the computing device in FIG. 1.

### DETAILED DESCRIPTION

In general, the word “module”, as used herein, refers to logic embodied in hardware or firmware, or to a collection of software instructions, written in a programming language, such as, Java, C, or assembly. One or more software instructions in the modules may be embedded in firmware, such as in an EPROM. The modules described herein may be implemented as either software and/or hardware modules and may be stored in any type of non-transitory computer-readable medium or other storage device. Some non-limiting examples of non-transitory computer-readable media include CDs, DVDs, BLU-RAY, flash memory, and hard disk drives.

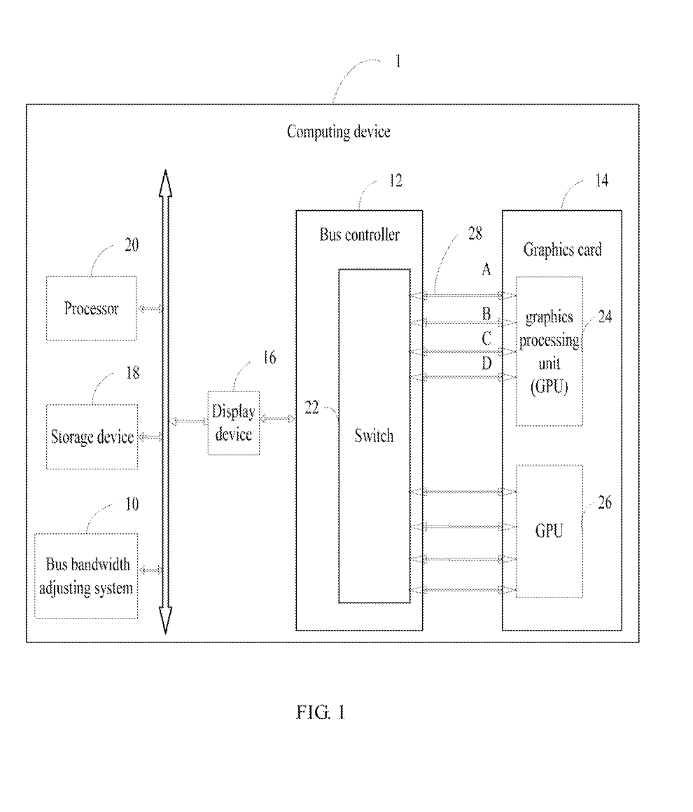

FIG. 1 is a block diagram of one embodiment of a computing device 1 including a bus bandwidth adjusting system 10. In one embodiment, the computing device 1 further includes a bus controller 12, a graphics card 14, a display device 16, a storage device 18, and at least one processor 20. The bus controller 12 includes a switch 22, and the graphics card 14 includes a first graphics processing unit (GPU) 24 and a second GPU 26. The bus controller 12 connects to the GPU 24 and the GPU 26 by a PCI-E bus 28. The PCI-E bus 28 includes a plurality of signal channels, such as signal channels “A,” “B,” “C,” and “D” as shown in FIG. 1.

The graphics card 14 is hardware that is installed in the computing device 1, and is responsible for rendering images on the display device 16 of the computing device 1.

Each of the first GPU 24 and the second GPU 26, in one embodiment, is a graphics chip installed on the graphics card 14. The first GPU 24 and the second GPU 26 receive the data flow from the bus controller 12 using the PCI-E bus 28 and control the graphics card 14 to render images on the display device 16 of the computing device 1.

The PCI-E bus 28 includes a plurality of signal channels (e.g., the signal channels “A,” “B,” “C,” and “D” as shown in FIG. 1) for transmitting signal between the graphics card 14 and the bus controller 12. In one embodiment, sixteen of all the signal channels can be designed specifically for the graphics card 14. Taking dual-GPUs as an example, the bus controller 12 connected to the first GPU 24 and the second GPU 26 using eight signal channels.

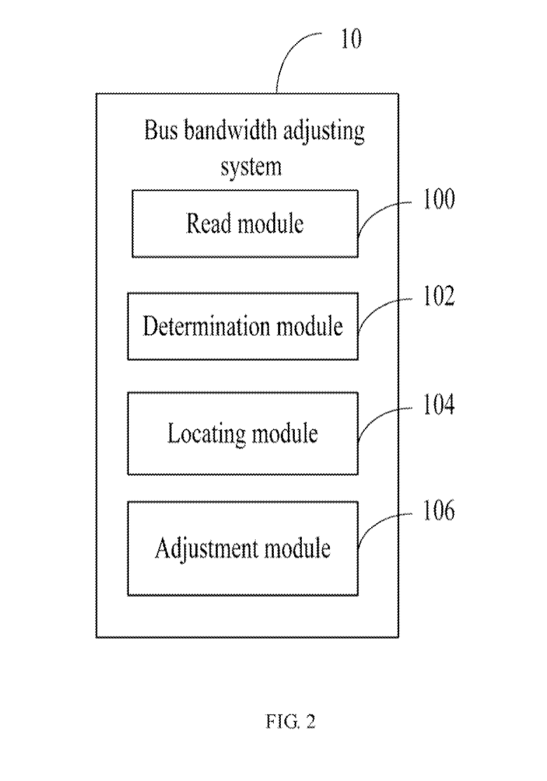

In one embodiment, the bus bandwidth adjusting system 10 includes a plurality of function modules (see FIG. 2 below), which include computerized code when executed by the processor 20, provide a method of adjusting the bus bandwidth of the computing device 1.

The at least one processor 20 may include a processor unit, a microprocessor, an application-specific integrated circuit (ASIC), and a field programmable gate array (FPGA), for example.

The storage device 18 may include any type(s) of non-transitory computer-readable storage medium, such as a hard disk drive, a compact disc, a digital video disc, or a tape drive. The storage device 18 stores the computerized code of the function modules of the bus bandwidth adjusting system 10.

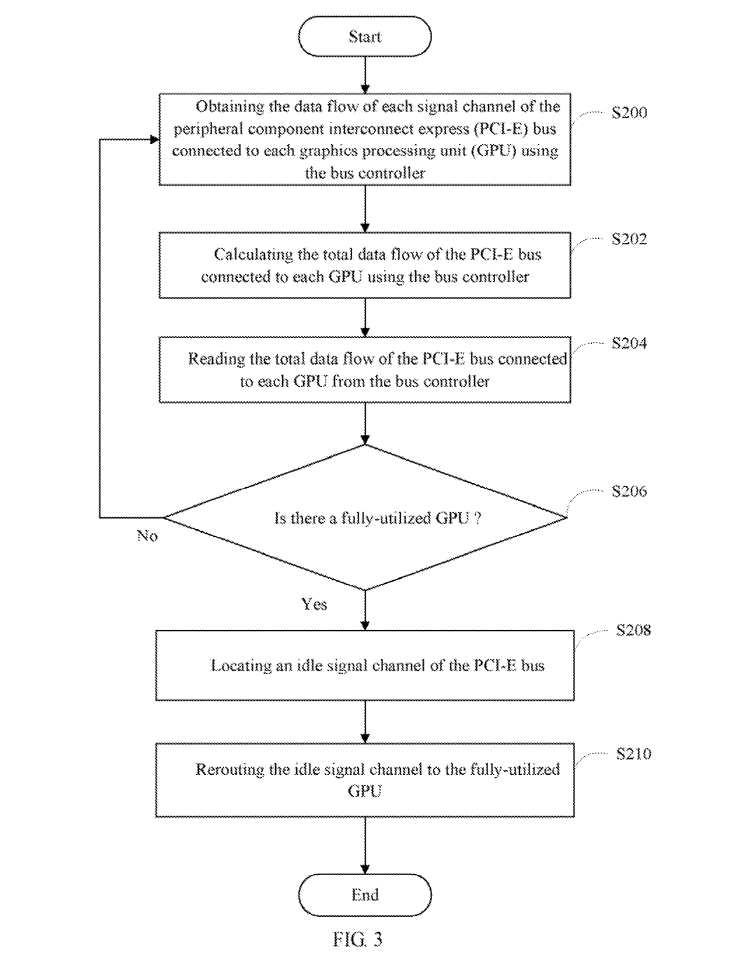

FIG. 2 is a block diagram of one embodiment of the function modules of the bus bandwidth adjusting system 10. In one embodiment, the bus bandwidth adjusting system 1 may include a read module 100, a determination module 102, a locating module 104, and an adjustment module 106. The functions of the function modules 100-106 are illustrated in FIG. 3 and described below.

FIG. 3 illustrates a flowchart of one embodiment of a method for adjusting a bus bandwidth of the computing device 1. Depending on the embodiment, additional steps may be added, others removed, and the ordering of the steps may be changed.

In step S200, the bus controller 12 obtains the data flow of each signal channel of the PCI-E bus 28 connected to the first GPU 24 and the second GPU 26, and stores information of the data flow in the bus controller 12. Referring to FIG. 1, each signal channel of the PCI-E bus may be represented by a letter, thus the signal channel A, the signal channel B, the signal channel C, and the signal channel D respectively.

In step S202, according to the data flow of each signal channel, the bus controller 12 calculates a first total data flow of the PCI-E bus 28 connected to the first GPU 24 and a second total data flow of the PCI-E bus 28 connected to the second GPU 26, and stores the first total data flow and the second total data flow in the bus controller 12.

In step S204, the read module 100 reads the first total data flow of the PCI-E bus 28 connecting to the first GPU 24 and the second total data flow of the PCI-E bus 28 connected to the second GPU 26 from the bus controller 12.

In step S206, according to the first total data flow of the PCI-E bus 28 connected to the first GPU 24 and the second total flow of the PCI-E bus 28 connected to the second GPU 26, the determination module 102 determines whether there is a fully-utilized GPU of which the bandwidth is already in a saturation state by performing steps as follows: the determination module 102 determines whether the first total data flow of the PCI-E bus 28 connected to the first GPU 24 and the second total data flow of the PCI-E bus 28 connected to the second GPU 26 is not less than the bandwidth of the PCI-E bus 28 connected to the first GPU 24 and the second GPU 26. When the total data flow of the PCI-E bus 28 connected to the first GPU 24 or that of the PCI-E bus 28 connected to the second GPU 26 is not less than the bandwidth of the PCI-E bus 28 connected to the first GPU 24 or the second GPU 26, the bandwidth of the PCI-E bus 28 connected to the first GPU 24 or the second GPU 26 is determined as being in a saturation state.

If there is a fully-utilized GPU of which the bandwidth is already in a saturation state, the procedure enters step S208. Otherwise if there is not a fully-utilized GPU, the procedure returns to step S200. For example, if the PCI-E bus 28 has sixteen signal channels, the PCI-E bus 28 allocates eight signal channels to each of the first GPU 24 and the second GPU 26. It is assumed that the bandwidth of each of the signal channels is 2 gigabytes (2 GB) per second, so the total bandwidth of the PCI-E bus 28 is 16 GB. per second. The determination module 102 determines whether the first total data flow of the PCI-E bus 28 connected to the first GPU 24 and the second total data flow of the PCI-E bus 28 connected to the second GPU 26 reaches 16 G.B per second.

In step S208, according to the data flow of each signal channel of the PCI-E bus 128 connected to the first GPU 24 and the second GPU 26, the locating module 104 locates an idle signal channel (e.g. the signal channel “B”) of the PCI-E bus 28 connected to the first GPU 24 or to the second GPU 26.

In step S210, the adjustment module 106 adjusts the idle signal channel to the fully-utilized GPU of which bandwidth is in a saturation state, through the switch 22. As shown in FIG. 1, it is deemed that the bandwidth of the PCI-E bus 28 connected to the second GPU 26 is in a saturation state and that the idle signal channels are the signal channel C and the signal channel D, the adjustment module 106 reroutes the signal channel C and the signal channel D from the first GPU 24 to the second GPU 26 by means of the switch 22.

Although certain embodiments have been specifically described, the present disclosure is not to be construed as being limited thereto. Various changes or modifications may be made to the embodiments without departing from the scope and spirit of the present disclosure.

What is claimed is:

1. A method for adjusting a bus bandwidth of a computing device, the computing device installed with a bus controller and a plurality of graphic processing units (GPUs), the method comprising:
obtaining a data flow of each signal channel of the peripheral component interconnect express (PCI-E) bus connected to each GPU using the bus controller;
calculating a total data flow of the PCI-E bus connected to each GPU using the bus controller according to the data flow of each of the signal channels;
determining whether there is a fully-utilized GPU according to the total data flow of the PCI-E bus;
locating an idle signal channel of the PCI-E bus according to the data flow of each of signal channels if there is a fully-utilized GPU; and
rerouting the idle signal channel to the fully-utilized GPU using a switch of the bus controller.

2. The method according to claim 1, wherein the computing device further comprises a graphics card connected to the bus controller using the PCI-E bus.

3. The method according to claim 2, wherein each of GPUs is a graphics chip installed on the graphics card.

4. The method according to claim 1, wherein the graphics card comprises a first GPU consisting of eight signal channels, and a second GPU consisting of eight signal channels.

5. A computing device, comprising:
a bus controller;
a plurality of graphic processing units (GPUs);
a storage device;
at least one processer; and
one or more modules that are stored in the storage device and executed by the at least one processer, the one or more modules comprising instructions to:
obtain a data flow of each signal channel of the PCI-E (peripheral component interconnect express) bus connected to each GPU using the bus controller;
calculate a total data flow of the PCI-E bus connected to each GPU using the bus controller according to the data flow of each of the signal channels;
determine whether there is a fully-utilized GPU according to the total data flow of the PCI-E bus;
locate an idle signal channel of the PCI-E bus according to the data flow of each of signal channels if there is a fully-utilized GPU; and
reroute the idle signal channel to the fully-utilized GPU using a switch of the bus controller.

6. The computing device according to claim 5, further comprising a graphics card connected to the bus controller using the PCI-E bus.

7. The computing device according to claim 6, wherein each of GPUs is a graphics chip installed on the graphics card.

8. The computing device according to claim 5, wherein the graphics card comprises a first GPU consisting of eight signal channels, and a second GPU consisting of eight signal channels.

9. A non-transitory computer-readable storage medium having stored thereon instructions capable of being executed by a processor of a computing device, causes the processor to perform a method for adjusting a bus bandwidth of the computing device, the computing device being installed with a bus controller and a plurality of graphic processing units (GPUs), the method comprising:
obtaining a data flow of each signal channel of the peripheral component interconnect express (PCI-E) bus connected to each GPU using the bus controller;
calculating a total data flow of the PCI-E bus connected to each GPU using the bus controller according to the data flow of each of the signal channels;
determining whether there is a fully-utilized GPU according to the total data flow of the PCI-E bus;
locating an idle signal channel of the PCI-E bus according to the data flow of each of signal channels if there is a fully-utilized GPU; and
rerouting the idle signal channel to the fully-utilized GPU using a switch of the bus controller.

10. The storage medium according to claim 9, wherein the computing device further comprises a graphics card connected to the bus controller using the PCI-E bus.

11. The storage medium according to claim 10, wherein each of GPUs is a graphics chip installed on the graphics card.

12. The storage medium according to claim 9, wherein the graphics card comprises a first GPU consisting of eight n signal channels, and a second GPU consisting of eight signal channels.
